(19) United States
(12) Patent Application Publication
(10) Pub. No.: US 2009/0327143 A1
(43) Pub. Date: Dec. 31, 2009

(54) Method and apparatus to send cash to any person in the world

(76) Inventor: Fernando Morales, Rancho Viejo, TX (US)

Correspondence Address: Fernando Morales, 56 Pizarro Ave., Rancho Viejo, TX, 78575, US

(21) Appl. No.: 12/456,868

(22) Filed: Jun. 24, 2009

Related U.S. Application Data
(60) Provisional application No. 61/133,321, filed on Jun. 27, 2008.

(51) Int. Cl. G06Q 20/00; G06Q 40/00; G06Q 30/00; H04L 9/32

(52) U.S. Cl. 705/75; 705/44; 705/43; 705/26

(57) ABSTRACT

A method to send a monetary value corresponding to the value of a US dollar bill feed to a device operated by the person that want to send a cash to a friend or relative. In one embodiment of the invention, the person that wants to send monetary value to another person just places a phone call on the device described on this invention and during the conversation feeds one bill to the device which could be returned back if in few seconds there is no verification that a corresponding monetary value has been received by the other person, similarly additional bills could be fed to the device. To gain trust, the device could show the pictures of the recipient, sound bites and other information such as name, address, and account balance to mention some examples.

### CROSS-REFERENCE TO RELATED APPLICATION

This application claims priority under 35 U.S.C. sctn.119(e) of the U.S. Provisional Patent Application Ser. No. 61/133,321, filed on Jun. 27, 2008 the disclosure of which is hereby incorporated by reference thereto in its entirety.

### BACKGROUND OF THE INVENTION

1. Field of the Invention

The invention is directed to a method of sending cash using the device described herein to any person in the world in a way that the sender could feed a dollar bill during a phone conversation with the other person using the device.

More particularly, the invention is directed to a method and apparatus that give the user certainty that the cash fed to the device will arrive to the desired person in seconds, thus the bill could be returned to the sender if the confirmation of the transaction is not received within a number of seconds.

2. Description of Background and Relevant Information

It well known that billions of dollars are sent from millions of working persons in the U.S. to their relatives in the world on a regular basis. Western Union handles ninety percent of the money, charging ten dollars per transaction to be delivered next day and fifteen dollars per transaction to be delivered the same day. Clearly, the sender's cost of sending money to a relative impairs his/her ability to send one, five, or ten dollars. The method and apparatus described herein could allow immigrants to send any dollar bill they choose at any time without filing forms and be worries about the money in transit.

There is a need for an affordable method to allow immigrants to send a few dollar bills a day to their families that live outside the U.S.

### SUMMARY OF THE INVENTION

The present invention satisfies the aforementioned needs by providing a method to send dollar bills and pay service fees as a percentage of the bill denomination. To archive that the apparatus allows the user to place a call to a relatives phone number, if that phone number was used before to receive money, the sender could feed a bill during the conversation to the apparatus after verify that the person that answered the phone is the person he/she want. The first time user should register the telephone number of the person that he/she entered; this process is required to link the phone number with system in that particular country, which be responsible to deliver the monetary value of the fed bill. That initialization process could require the name, address, and other information from the recipient and from the sender as well. To capture all the required information, a service representative could join the conversation and help the initialization process, as well as to sell other services to the parties.

It is an object of the invention, therefore, to provide a method to move a monetary value from the sender to the receiver.

It is an object of the invention, therefore, to provide an apparatus to move a monetary value from the sender to the receiver.

It is an object of the invention, therefore, to provide a method to move a monetary value from the sender to the receiver during a phone conversation.

It is an object of the invention, therefore, to provide an apparatus to move a monetary value from the sender to the receiver during a phone conversation.

These and other advantages of the invention will become more fully apparent when the following detailed description of the invention is read in conjunction with the accompanying drawings.

### BRIEF DESCRIPTION OF THE DRAWINGS

Other aspects of the invention will be set forth in the following detailed description, which refer to the appended drawings in which:

FIG. 1 is a schematic illustration of the apparatus of the invention.

FIG. 2 is a schematic illustration of how the apparatus of the invention is connected to the world.

FIG. 3 is a schematic illustration of global interconnection of the networks involved.

### DETAILED DESCRIPTION OF THE INVENTION

The invention is directed to a method to ensuring an affordable dollar bill transmission between a sender and a receiver of the monetary value. Turning now to the drawings figures, the overall configuration of the invention and its components are described below.

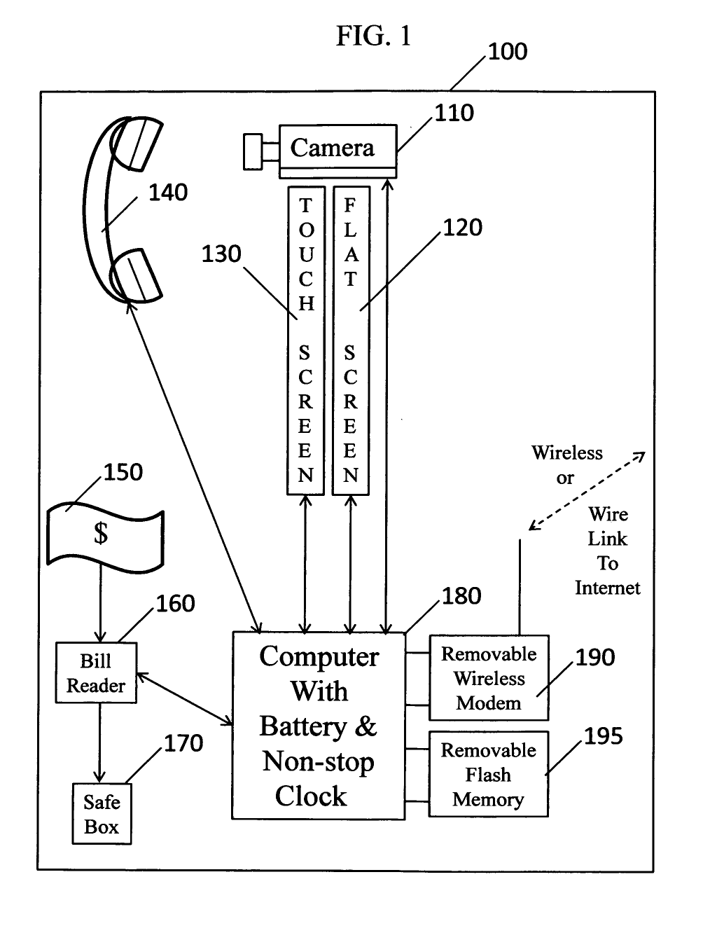

FIG. 1 essentially shows the internal parts of the apparatus 100 which will allow accomplishing the transmission of the dollar bills. A camera 110 could take a picture of the sender at any time and presented on the screen 120 to allow the sender to get in position for a better picture, this picture could be send to the receiver as well as to be part of the record. A touch screen 130 could be used instead of a regular keyboard to enter the phone number of the person to which the sender want to call using the handset 140, and during the conversation the bill 150 could be fed to the bill reader 160, which after a confirmation that the monetary value of that bill was received will store the bill 160 on the safe box 170, which could be removed from the device 100 by a security money service man, after an adequate identification verification procedure is passed. The computer 180 is controlling the functionality of the device 100 and using the modem 190 could send and receive encrypted information through wire or wireless connection to the network. The computer 180 could read important initialization data from the memory 195 as well as write data related to transactions.

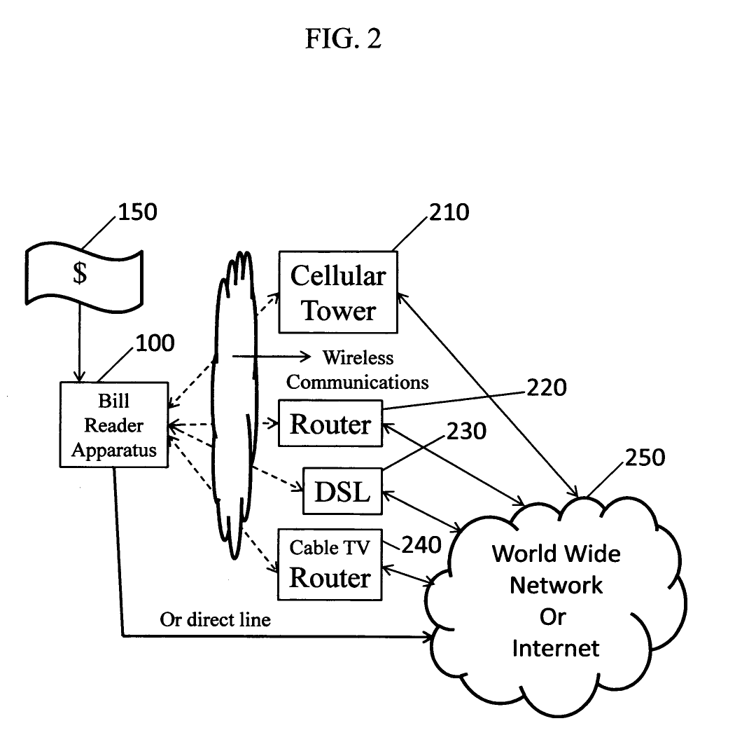

FIG. 2 essentially shows the alternative ways to connect the apparatus 100 to the world wide network 250. The apparatus 100 could be set to use the cellular tower 210 by replacing the modem 190 similarly using a wireless router 220 or wireless DSL 230 or a cable router 240 or a wire line through similar routers to the Internet 250.

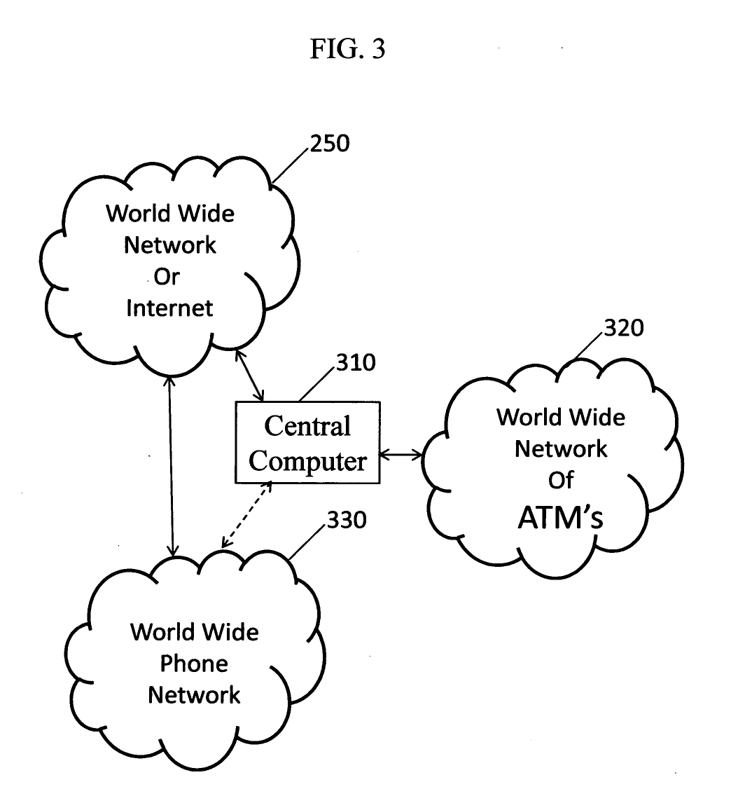

FIG. 3 essentially shows the global interconnections between the Internet 250 a central computer 310 the network of ATM's 320 and the phone network 330. These three networks will allow the apparatus 100 through the Internet 250 to send and receive digital information that can be a phone conversation over IP or data to pay for ATM's transactions.

Those skilled in the art of the present invention will recognize that other embodiments using the concepts described herein are also possible, to move a monetary value on an affordable way, such alternatives and equivalents being encompassed within the claimed invention.

1. A method to send cash from the U.S.A. to any person in the world through a network computer attached to a bill acceptor, said method comprising: that the one that sends a bill operates the mentioned computer apparatus.

2. A method according to claim 1, further comprising: that the apparatus has means for permitting the user to enter the telephone number of the person that will receive the monetary value of the bill.

3. A method according to claim 1, further comprising: that the apparatus has means for permitting the user to enter the bank account of the person that will receive the monetary value of the bill.

4. A method according to claim 1, further comprising: that the apparatus has means for permitting the user to enter the credit card account of the person that will receive the monetary value of the bill.

5. A method according to claim 1, further comprising: that the apparatus has means for permitting the user to verify the identity of that person that will receive the monetary value of the bill.

6. A method according to claim 1, further comprising: that the apparatus has means for permitting the user to verify the denomination of the bill captured.

7. A method according to claim 1, further comprising: that the apparatus has means for permitting the user to verify the delivery of the monetary value or get the bill back.

8. A method according to claim 1, further comprising: that the apparatus has means for permitting the user to verify past cash transactions to any person which he or she sent monetary value by using a secret code.

9. A method according to claim 1, further comprising: that the apparatus has means for permitting the user to send a cell phone to the person that will receive the monetary value of the bill.

10. A method according to claim 1, further comprising: that the apparatus has means for permitting the user to talk with the person that will receive the monetary value of the bill.

11. A method according to claim 1, further comprising: that the apparatus has means for permitting the user to talk with a sales representative of the money transmission service.

12. A method according to claim 1, further comprising: that the apparatus has means for permitting the user to talk with the person that will receive the monetary value of the bill and with a sales representative of the money transmission service at the same time.

13. A method according to claim 1, further comprising: that the apparatus has means for permitting the user to see an image of the person that will receive the monetary value of the bill.

14. A method according to claim 1, further comprising: that the apparatus has means for permitting the user to see an image of the sales representative of the money transmission service.

15. A method according to claim 1, further comprising: that the apparatus has the means for taking an image from the user and sending it to the sales representative of the money transmission service.

16. A method according to claim 1, further comprising: that the network is the internet or any other World Wide Web.

17. A method according to claim 1, further comprising: that the apparatus has the means to be Tirelessly connected to a network.

18. A method according to claim 1, further comprising: that the apparatus is connected to a network through a telephone carrier broad band infrastructure.

19. A method according to claim 1, further comprising: that the apparatus is mounted on a vehicle.

20. A method according to claim 1, further comprising: that the apparatus looks like a public telephone.

21. A method according to claim 1, further comprising: that the apparatus has the means for permitting a security person who uses the apparatus to open it and take the cash cassette after a positive verification of his/her identification code and/or image.

22. A method according to claim 1, further comprising: that the apparatus has the means for recording information for each bill accepted by the apparatus.

23. A method according to claim 22, further comprising: that the apparatus has the means for removing the recording information on a portable non-volatile device.

24. A method according to claim 22, further comprising: that the apparatus has the means for transmitting the recording information through the network connection.

25. A method according to claim 1, further comprising: that the apparatus has the means for encrypting information before sending it through the network.

26. A method according to claim 1, further comprising: that the apparatus has means for decrypting information after receiving it.

27. A method according to claim 1, further comprising: that the apparatus has the means for using a clock to further protect the integrity of the information.

28. A method according to claim 1, further comprising: that the apparatus has the means for setting the initial parameters using a removable non-volatile memory.
